(19) United States
(12) Patent Application Publication
(10) Pub. No.: US 2014/0361870 A1
(43) Pub. Date: Dec. 11, 2014

(54) UNAUTHORIZED PERSON DETERRENT APPARATUS, SYSTEM, AND METHOD OF USE THEREOF

(71) Applicant: ANTHONY R. CATALFAMO, SCHENECTADY, NY (US)

(72) Inventor: ANTHONY R. CATALFAMO, SCHENECTADY, NY (US)

(21) Appl. No.: 13/910,398

(22) Filed: Jun. 5, 2013

(51) Int. Cl. G08B 15/00

(52) U.S. Cl. CPC G08B 15/00
USPC 340/5.31

(57) ABSTRACT

A unauthorized person deterrent apparatus is shown comprising a ingress cover, a ingress cover opening mechanism, a ingress cover opening mechanism deactivator, a ingress cover opening mechanism deactivator switch, a audible alarm deactivator, and a ingress cover locking mechanism. The ingress cover opening deactivator switch is configured to operate the ingress cover opening mechanism deactivator, the deactivator in turn to cause the ingress cover opening mechanism to deactivate, and the ingress cover to close and lock.

### FIELD OF TECHNOLOGY

The following relates to embodiments of a unauthorized person deterrent apparatus, system, and method of use, and more specifically to embodiments of a unauthorized person deterrent system.

### BACKGROUND

Traditionally, building security systems have been used in various industries. Security systems in the form of security points, check points, magnetic scanners, alarms, electrical fields, windows, locks, barricades, and such have been seen. They may be moveable or permanently fixed structures. Additionally, extensive new hardware and equipment may be used in these deterrents. Some old systems may be repaired or completely discarded and new systems may be used in their place. Generally, a lot of time, money, equipment, and space may be needed to make any upgrades or conversions. Upgrades or conversions may become obsolete if the structures which house them are changed or modified. Moreover, structures housing the deterrent systems may be abandoned or discarded, and the deterrent systems may be useless because they were custom made for those housing structures. Many people and organizations may be discouraged from making desirable modifications or changes to existing structures, which house deterrent systems, because such modifications or changes may render the deterrent systems obsolete, ineffective, or diminished in effect.

It is clear that this entire process of installing, modifying, upgrading, or uninstalling a deterrent system can be very tedious, time consuming, and expensive. It will need extensive modifications and changes to be made to an existing housing structure. The old methods of installing or upgrading security systems result in a huge waste of finances, man power, and down time. Down time could result in potentially dangerous situations.

Thus, there is a need for a unauthorized person deterrent system or method which will reduce waste and down time. The embodiments described herein provide for such a unauthorized person deterrent system, apparatus, and method. The embodiments reduce waste, increase efficiency of existing systems, and as such minimize down time.

SUMMARY

A first aspect relates generally to a unauthorized person deterrent apparatus comprising a ingress cover, a ingress cover opening mechanism, a ingress cover opening mechanism deactivator, a ingress cover opening mechanism deactivator switch, a audible alarm deactivator, and a ingress cover locking mechanism, wherein operating the ingress cover opening deactivator switch may cause the operation of the ingress cover opening mechanism deactivator, the deactivator may then cause the ingress cover opening mechanism to deactivate thereby causing the ingress cover to close. The ingress cover may lock after closing. The operating of the deactivator switch may also cause the operating of the audible alarm deactivator.

A second aspect relates generally to a method of using a unauthorized person deterrent apparatus comprising providing a ingress cover, providing a ingress cover opening mechanism, providing a ingress cover opening mechanism deactivator, providing a ingress cover opening mechanism deactivator switch, providing a audible alarm deactivator, providing a ingress cover locking mechanism, and operating the ingress cover opening deactivator switch, and causing the operation of the ingress cover opening mechanism deactivator, causing the ingress cover opening mechanism to deactivate, and causing the ingress cover to close, and causing the ingress cover to lock.

A third aspect relates generally to a unauthorized person deterrent system comprising a ingress cover, a ingress cover opening mechanism, a ingress cover opening mechanism deactivator, a ingress cover opening mechanism deactivator switch, a audible alarm deactivator, and a ingress cover locking mechanism, wherein the ingress cover opening deactivator switch is operated, the ingress cover opening mechanism deactivator is operated, the ingress cover opening mechanism is deactivated, and the ingress cover is closed and locked. The deactivator switch may also operate the audible alarm deactivator.

The foregoing and other features of construction and operation will be more readily understood and fully appreciated from the following detailed disclosure, taken in conjunction with accompanying drawings.

### BRIEF DESCRIPTION

Some of the embodiments will be described in detail, with reference to the following figures, wherein like designations denote like members, wherein:

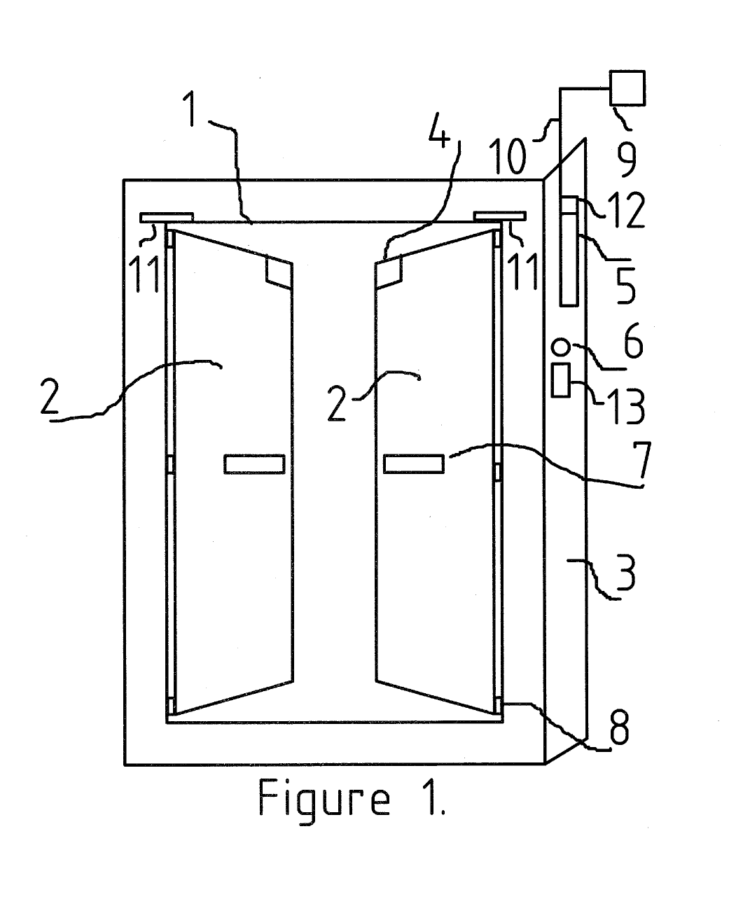

FIG. 1 depicts a front view of an embodiment of a unauthorized person deterrent apparatus showing two ingress covers in a partially open position, ingress covers are present in an ingress within a structure. Also seen are various elements of the embodiment of the unauthorized person deterrent apparatus;

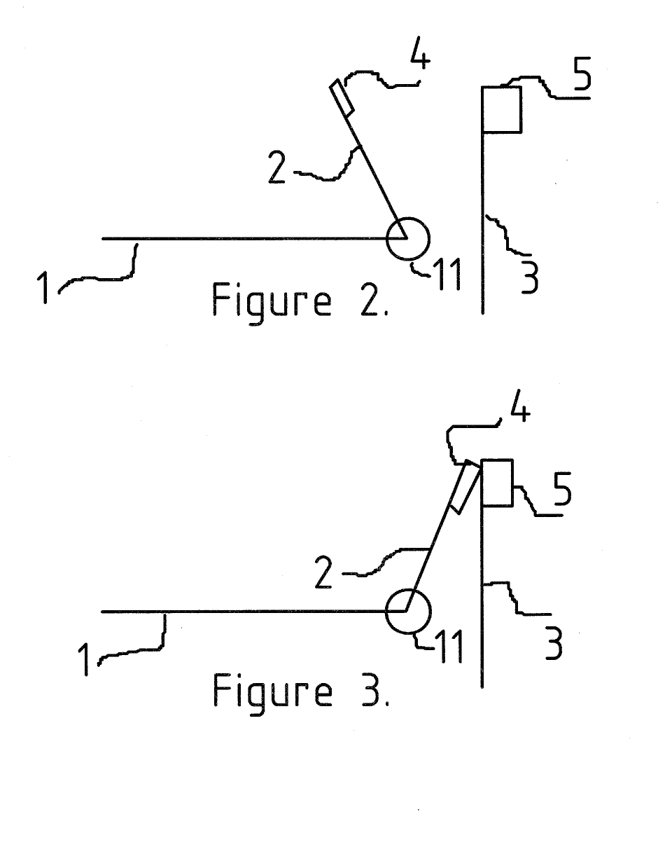

FIG. 2 depicts a top view of an embodiment of a unauthorized person deterrent apparatus where the ingress cover 2 is in a partially open position within the ingress, and the opening mechanism part 4 of the ingress cover 2 is not in contact with the ingress cover opening mechanism 5;

FIG. 3 depicts a top view of an embodiment of a unauthorized person deterrent apparatus where the ingress cover 2 is in a partially open position within the ingress, and the opening mechanism part 4 of the ingress cover is in contact with the ingress cover opening mechanism 5;

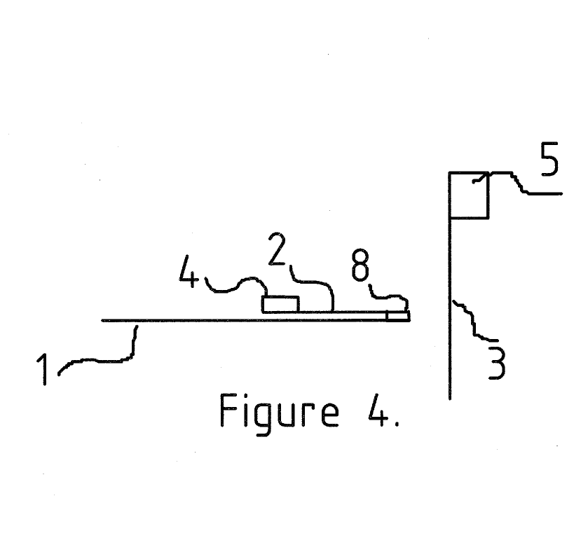

FIG. 4 depicts a top view of an embodiment of a unauthorized person deterrent apparatus where the ingress cover 2 is in fully closed position within the ingress thereby blocking movement of person or object across the ingress 1, and the opening mechanism part 4 of the ingress cover 2 is not in contact with the ingress cover opening mechanism 5;

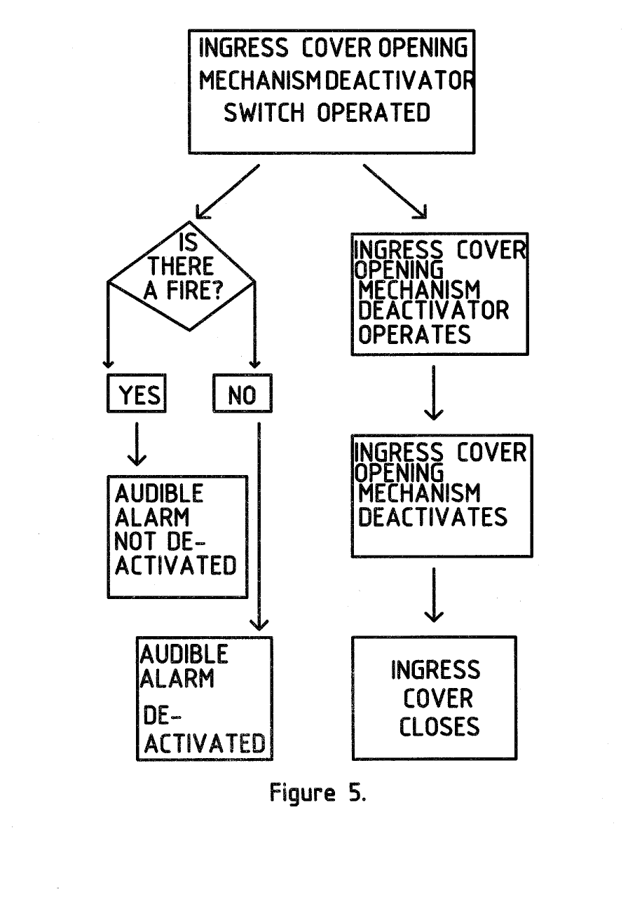

FIG. 5 is a flow chart of one of the embodiments of the present disclosure showing an exemplary sequence of events in of the method of use of the unauthorized person deterrent apparatus;

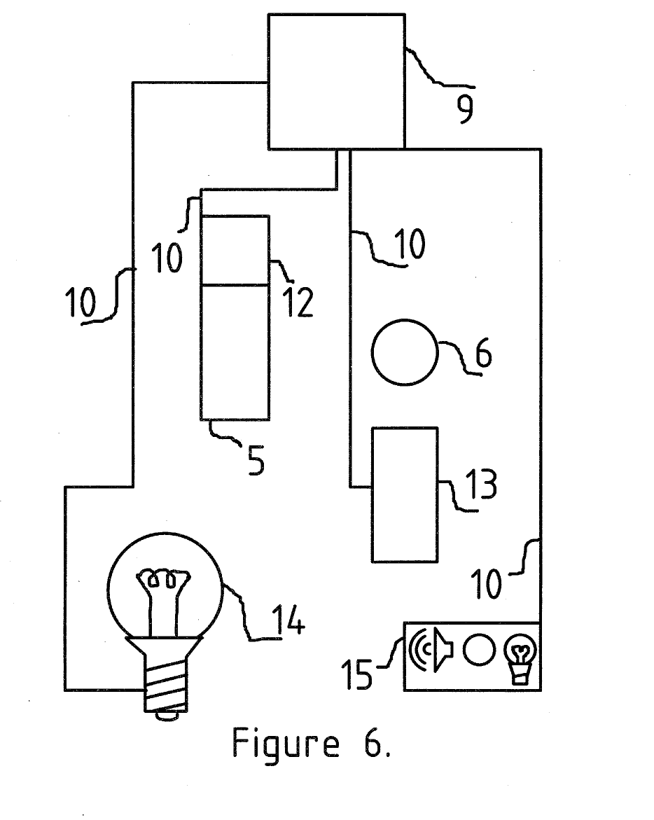

FIG. 6 is a circuit diagram of an embodiment of a unauthorized person deterrent apparatus showing the ingress cover opening mechanism deactivator switch 9 connected to various elements of an embodiment of the present disclosure;

### DETAILED DESCRIPTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

The following description is presented to enable a person skilled in the art to make and use the embodiments of the present disclosure. Various modifications to the illustrated embodiments will be readily apparent to those skilled in the art, and the generic principles herein may be applied to other embodiments and applications without departing from the present disclosure and its teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments as presented here may be used when implementing, installing, upgrading, changing, or moving a unauthorized person deterrent apparatus, system or method as applicable. The embodiments as shown in the disclosure may be used to utilize or install a unauthorized person deterrent apparatus, in many different housing structures, buildings, rooms, entrances, and the such. In the instant example, in FIG. 1, a unauthorized person deterrent system is shown along with an audible alarm. Alternate embodiments may have only the deterrent system or apparatus with no audible alarm.

As shown in FIG. 1, a unauthorized person deterrent apparatus is shown in front view. The apparatus may include a ingress cover 2, which cover the ingress 1, a ingress cover opening mechanism 5, a ingress cover opening mechanism part 4, a ingress cover opening mechanism deactivator 12, a ingress cover opening mechanism deactivator switch 9, a audible alarm deactivator 13, and a ingress cover locking mechanism 7. Operating the ingress cover opening mechanism deactivator switch 9 may cause the operation of the ingress cover opening mechanism deactivator 12, the ingress cover opening mechanism deactivator 12 may then cause the ingress cover opening mechanism 5 to deactivate thereby causing the ingress cover 2 to close. The ingress cover 2 may lock in the closed position by the operation of the ingress cover locking mechanism 7.

Alternate embodiments of the ingress cover may be of any commonly known type such as a door, single panel door, multiple panel door, revolving door, door frame, entrance way, curtain, hinged door, sliding door, and the such. In the instant embodiment of the disclosure, as shown in FIG. 1, the ingress cover 2 is a hinged two-panel doorway. This type of door is commonly known, wherein each of the two door panels is generally rectangular in shape, with a longer vertical edge and shorter horizontal edge. Generally, the panels are attached by hinges along one of their vertical edges such that when the panels are held in an open position, the ingress allows movement of people, animals, and objects across it. Ingress cover 2 is mechanically attached to ingress 1 by a hinge 8. There may be multiples of hinge 8, as depicted in FIG. 1. Ingress cover 2 pivots on hinge 8 between a closed position to an open position. In many buildings, these doors are fitted with some type of opening mechanism. Opening mechanism may be mechanical, electromechanical, pneumatic, a combination of these, and other similar structures. Opening mechanisms may also include mechanisms which may simply hold the ingress covers open, such mechanisms may include clamps, pegs, hook and loop type fasteners, permanent magnets, electromagnets, pneumatic plungers, plungers, hydraulic systems, ball and spring, ball-spring-notch, and the such. Opening mechanisms may also be electric motors, motor and pulley arrangements, springs, resilient members, flexible members, and similar mechanisms. The ingress cover opening mechanism 5 may be operationally fixed on the structure 3 in which the ingress 1 is present. Ingress cover 2 may be operationally employed in such ingress 1. The ingress cover opening mechanism 5 may be used in conjunction with a ingress cover opening mechanism part 4, which may be operationally fixed to the ingress cover 2. For example, ingress cover opening mechanism 5 may be an electromagnet, and the ingress cover opening mechanism part 4 may be a ferromagnetic plate, thereby allowing the ingress cover 2 to be opened by a person and then held in the open position by the magnetic attraction between the electromagnet and the ferromagnetic plate. It will be appreciated by one with ordinary skill in the art that the ingress cover opening mechanism 5 may be any mechanism which may be used to open the ingress cover 2. For example, ingress cover opening mechanism 5 may be a hydraulic pushrod which may have a pivoting point of attachment on the ingress cover 2. The pivoting point of attachment in this example will constitute the ingress cover opening mechanism part 4.

The ingress cover 2 may also employ ingress cover closing mechanism 11. Ingress cover closing mechanism 11 may be structures or mechanisms which may exert an opposing force to the ingress cover opening mechanism 5. For example, a ingress cover opening mechanism 5 may be an electric motor, attached to the ingress cover 2 by a ingress cover opening mechanism part 4 such as cable and pulley arrangement, and the ingress cover closing mechanism 11 may be a circular spring or sprung hinge. FIG. 1 depicts the ingress cover closing mechanism 11 in the form of a circular spring in side view. FIGS. 2 and 3 depict ingress cover closing mechanism 11 in cross section view. It will be clear to one having ordinary skill in the art that in order to open the ingress cover 2, the force exerted by the ingress cover opening mechanism 5 will have to overcome the force exerted by the ingress cover closing mechanism 11, and in order to close the ingress cover, the force exerted by the ingress cover closing mechanism 11 will have to overcome the force exerted by the ingress cover opening mechanism 5. An example of such an arrangement is showing in FIG. 3, where one panel of the ingress cover 2 is held in the open position by the ingress cover opening mechanism 5. In the instant example, the panel may be first pushed and opened by a person, and then held in the open position by an electromagnet housed in the structure 3. In this example of the disclosure, deactivation of the electromagnets may cause the panels to close because the force exerted by the ingress cover closing mechanism 11 in the form of a circular spring may overcome the force exerted by gravity and friction on the ingress cover 2, and the force exerted by the ingress cover opening mechanism 5 may be zero due to the deactivation of the electromagnets

The ingress cover opening mechanism 5 may be deactivated by the ingress cover opening mechanism deactivator 12. The deactivator 12 may be a relay switch which provides electricity to the electromagnets in the closed position and stops the flow of electricity to the electromagnets in the open position. The position of the relay in either the closed or open position may be controlled by a ingress cover opening mechanism deactivator switch 9. The ingress cover opening mechanism deactivator switch 9 may communicate with the cause the ingress cover opening mechanism deactivator 12 via a deactivator circuit 10, and may cause the relay to go from a closed position to an open position. One skilled in the art would know that a relay switch may have a primary and a secondary circuit in it. The ingress cover opening mechanism deactivator switch 9 may cause a change in the primary circuit, thereby causing a change in the secondary circuit. For example, the ingress cover opening mechanism deactivator switch 9 may cause a deactivation of the primary circuit in a relay thereby opening the secondary circuit in the relay, which in turn may cause the deactivation of any circuit dependant on the secondary circuit of the relay, which in the instant example would be the deactivation of the electromagnets holding the ingress cover 2 panels of the ingress cover 2 open. It will be appreciated by a person having ordinary skill in the art that an open or the opening of a circuit means a discontinuity in a circuit, and discontinuity in the flow of electrons. Closed or the closing of a circuit means the opposite. Furthermore, it will be appreciated by a person having ordinary skill in the art that relays may be electromechanical, solid state, contactors, reed relays, latching relays, wireless relays, and the such. The choice of relays may depend on several factors and requirements such as existing infrastructure in the housing structure, reliability of the deterrent system, complexity of the deterrent system, speed of the relay, sensitivity of the relay, electromagnetic interference, longevity, desired life span, and so on. The ingress cover opening mechanism deactivator switch 9 may be a mechanical switch placed at a remote location. There may be multiple switches controlling a single opening mechanism, or there may be a single switch controlling multiple opening mechanisms. Alternatively, there may be a separate switch for each opening mechanism. Ingress cover opening mechanism deactivator switch 9 may be a solid state switch, microprocessor controlled switch, a microprocessor, a computer based switch, a cell phone button, a smart phone application, a smart phone button, a touch screen button, an icon, a timer, a computer icon button, an icon on a computer screen, an icon on a mobile device, an icon on a wearable optical electronic device, an icon in augmented reality glasses, sound command given via bone conduction device, a programmed button on a telephone, a button on a radio device, a switch on a wireless device, a motion detecting device, an optical device, a photo electric device, a sound activated device, voice activated device, a gesture controlled device, an eye motion activated device, a software application, and the such. It will be appreciated by one skilled in the art that a ingress cover opening mechanism deactivator switch 9 may be any switch that may have the capability to create an interrupt in a circuit. It should be noted that a switch may also be a simple device such as pull string, pedal, or other similar device.

The ingress cover opening mechanism deactivator switch 9 may be operated by a person, timer device, or by a sensor programmed to send a signal upon the happening or not happening of a certain event. For example, when the unauthorized person deterrent apparatus of the present disclosure is installed in a building entrance, a watcher person may be able to watch the ingress 1 from a remote location via a camera-video screen set up. The watcher may have on his or her computer, an icon which represents the ingress cover opening mechanism deactivator switch 9. When the watcher sees an unauthorized person entering the building, the watcher may hit the ingress cover opening mechanism deactivator switch 9 on his computer screen which may set off a chain of events as follows: the ingress cover opening mechanism deactivator 12 may operate, ingress cover opening mechanism deactivator may deactivate the ingress cover opening mechanism 5, the ingress covers 2 will close. If the ingress covers have locking mechanism 7 on them, the covers may lock. The locking mechanism 7 may be so designed as to allow the ingress covers to lock in only one direction. That is, the unauthorized person may be prevented from opening the ingress covers, but a person on the opposite side of the covers may be able to open the doors by operating some lever or button. In other words, the ingress covers, such as doors, may be opened from only one side. For example, if doors to a room are closed, a person outside the room may not be able to open them, but occupants of the room may be able to open the doors. This may be particularly important if evacuation of the building may be required. Additionally, the unauthorized person side of the ingress covers may have provision to be unlocked by firemen, policemen, law enforcement personnel, or authorized persons with a key or code. Locking mechanism 7 may be of a certain kind to comply with local regulations, such as approved safety locking hardware for doors. For example, a school building may have certain code requirements and locking hardware may be chosen from a list of approved locking hardware to best suit its use as per the present disclosure. The doors may not be permanently locked or even locked for very long periods. In some instances, the doors may be locked for only giving enough time for law enforcement or any other person to stop an unauthorized person from gaining entry into a building, or gaining entry to any section or the building, to apprehend an unauthorized person, or to simply immobilize either completely or partially the unauthorized person, or to secure enough time to move the occupants of a building from one location to another, or when a need to relocate occupants and objects may arise. For example, in the case of an unauthorized person entering a school building, children in the school building may be moved from one classroom to another or to a safe location, and the deterrent system of the present disclosure may allow a series of entrances to be closed as per the arising situation and circumstances, and personnel supervising the movement of the children may be able to lock or open ingress covers or doors in any sequence as needed to buy time to move the children to safety.

An alternate embodiment of the unauthorized person deterrent system may be connected to a fire alarm system. A fire alarm system may be connected to a ingress cover opening mechanism deactivator to allow for automatic closing of doors in a building in case of a fire. A fire alarm system may also have an audible part to alert occupants of a fire hazard. In the instant embodiment of the unauthorized person deterrent system, the deterrent system may be connected to such a fire alarm system, wherein the activation of the ingress cover opening mechanism deactivator switch may, in addition to activating the ingress cover opening mechanism deactivator, may also cause the audible part of a fire alarm system to be disabled. This arrangement may be particularly beneficial when there is no fire but it is desirable that the doors in a building be closed to deter an unauthorized person from entering or moving about in a building. In this situation, the unauthorized person will not be informed that any action was taken against him or her, and will not be alerted by any audible signal. The doors in a building may be closed and occupants may be moved to safety, all while the unauthorized person is oblivious to the changes in alertness levels of the occupants, any changes in the position of objects or doors, any locking of doors and areas, or any alerting of law enforcement or other people. Such an arrangement may be particularly beneficial in case the unauthorized person is an armed intruder. It is possible that loud sounds may trigger: increased anger and determination in the armed intruder to either cause more damage to the building and occupants, increased violence in order to secure a path to escape, secure hostages, or an increase in the speed of the intruder in the building or premises. An added advantage may be that the deterrent system of one of the embodiments of the present disclosure may be used in conjunction of an existing fire alarm system thus saving time and cost of installing a completely new safety system or hardware in a building. Such an embodiment of the present disclosure may also reduce the down time of upgrading to a unauthorized person deterrent system.

In an alternative embodiment of the disclosure, as shown in FIG. 6, the ingress cover opening mechanism deactivator switch may connected by deactivator circuit 10 to an emergency light 14. It may be desirable to not only deactivate the audible signal, but to also deactivate any blinking emergency light 14 associated with a fire alarm system. A common color associated with fire alarm lights is red. If these commonly known colored lights would not blink, the unauthorized person will not be informed that any action was taken against or in response to him or her, and will not be alerted by blinking lights or visual signal. The doors in a building may be closed and occupants may be moved to safety, all while the unauthorized person is oblivious to the changes in alertness levels of the occupants, any changes in the position of objects or doors, any locking of doors and areas, and any alerting of law enforcement or other people. Such an arrangement may be particularly beneficial in case of an unauthorized person such as an armed intruder, because visual signals such as blinking lights may trigger increased anger and determination in the armed intruder to either cause more damage to the building and occupants, increased violence in order to secure a path to flee, secure hostages, or increase the speed of the intruder in the building or premises. In an alternate embodiment of the present disclosure, the ingress cover opening mechanism deactivator switch 9 may be connected to an alerting system 15 by deactivator circuit 10, and the activation of the ingress cover opening mechanism deactivator switch 9 may cause the activation of the alerting system 15. Alerting system 15 may be audio, visual, olfactory, mechanical, electronic, or a combination of these. Alerting system 15 may alert occupants of the building by various methods as described in the present disclosure, drawings, and claims. Alerting system may send information to law enforcement through automated telephonic messaging, radio transmissions, wireless transmissions, electronic means, audio means, optical means, olfactory means, and the such. Alerting system may have its own power back up in case there is a power failure. As would be understood by a person with ordinary skill in the art, the unauthorized person deterrent apparatus may need a source of electrical power to operate. It is also commonly understood that power supply may be interrupted by various factors such as weather, natural calamities, power grid failures, power failures, or by human intervention. The unauthorized person deterrent system may have a power back up system, such as batteries, generator, or alternate grids. For example, the alerting system may be a series of alerting visual cues or clues. Alerting visual clues may be specifically located but regular type light bulbs, colored lights hidden away from plain sight but visible to persons having knowledge of their location, icons displayed on a computer screen, icons on a mobile device, blinking or steady lights on mobile devices. Visual cues or clues may also be change in the intensity of specific or all lighting in a building, such as dimming or increased brightness of lights. The visual clues may alert a trained or informed person about the presence of a unauthorized person in the building, and the visual cues may trigger certain action that may be taken. The cues and clues may be interchangeably used depending on the training and situation. Visual clues may also include the closing of doors in a building without the fire alarm sounds going off. This would let the occupants know that even though the doors were closed, there is no fire because the fire alarm sounds or lights did not go off Therefore, it may become clear to the occupants that there is a possible unauthorized person in the building, and that they need to be careful about their movements, and there may be a concern of their safety.

In an alternate embodiment of the present disclosure, when a watcher observes an unauthorized person entering the building, the watcher may activate the ingress cover opening mechanism deactivator switch 9, for example, on his computer screen, and this deactivator switch 9 may, in isolation or in addition to, the resulting events as described in the present disclosure, may also cause law enforcement agencies to be automatically notified. In this embodiment, not only will the occupants of a building be informed of a possible presence of an unauthorized person in the building, but help from law enforcement personnel may also be summoned automatically.

In an alternate embodiment of the present disclosure, when a watcher observes an unauthorized person entering the building, the watcher may hit the ingress cover opening mechanism deactivator switch on his computer screen and this deactivator switch may, in isolation or in addition to, the resulting events as described in the present disclosure, may activate the alerting system 15. In this alternate embodiment, the alerting system may cause a certain smell to be released, which may inform the occupants of the building of a possible presence of an unauthorized person in the building. This smell may not be anything extraordinary or disagreeable, it may be a commonly known smell such as perfume or chemical smell, and occupants may be trained to identify the olfactory

It might be possible that the system were a “scaled up” version of the system and could be implemented to handle extra functions and/or material. Different buildings and structures may have different requirements.

In an alternate embodiment of the present disclosure, when a watcher observes an unauthorized person entering the building, the watcher may operate the ingress cover opening mechanism deactivator switch 9 which in turn may activate the alerting system 15. In this embodiment, the alerting system 15 may, in isolation or in addition to, the resulting events as described in the present disclosure, cause a certain sound tune to be generated , which may inform the occupants of the building of an unauthorized person in the building. Such a sound may not be loud or commonly associated with an alarm sound, but may be a seemingly innocent sound. For example, in a school building, a nursery rhyme may be played at a low volume, and it would not seem out of place to an intruder who lacks knowledge of such an arrangement. The sound may be changed on a daily, weekly, monthly, yearly basis, or rotated, so that only occupants would know the audible clues and cues.

Although certain embodiments of the present disclosure will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present disclosure are illustrated in detail in the accompanying drawings, wherein like reference numerals refer to like elements throughout the drawings.

What is claimed is:

1. A unauthorized person deterrent apparatus comprising:
a ingress cover;
a ingress cover opening mechanism;
a ingress cover opening mechanism deactivator;
a ingress cover opening mechanism deactivator switch;
wherein operating the ingress cover opening deactivator switch causes: the operation of the ingress cover opening mechanism deactivator, the ingress cover opening mechanism to deactivate, and the ingress cover to close.

2. The unauthorized person deterrent apparatus of claim 1, wherein the unauthorized person deterrent apparatus has a audible alarm deactivator.

3. The unauthorized person deterrent apparatus of claim 1, wherein the unauthorized person deterrent apparatus has a ingress cover locking mechanism.

4. The unauthorized person deterrent apparatus of claim 2, wherein the operation of the ingress cover opening mechanism deactivator switch causes the operation of the audible alarm deactivator.

5. The unauthorized person deterrent apparatus of claim 3, wherein the operation of the ingress cover opening mechanism deactivator switch causes the operation of the ingress cover locking mechanism.

6. The unauthorized person deterrent apparatus of claim 5, wherein the operation of the ingress cover locking mechanism locks the ingress cover in a closed position.

7. The unauthorized person deterrent apparatus of claim 1, wherein the unauthorized person deterrent apparatus has a alerting system.

8. The unauthorized person deterrent apparatus of claim 7, wherein the alerting system is selected from a group consisting of: audio, visual, olfactory, mechanical, electromechanical, audiovisual, and electronic.

9. The unauthorized person deterrent apparatus of claim 1, wherein the unauthorized person deterrent apparatus has a power back up system.

10. The unauthorized person deterrent apparatus of claim 1, wherein the unauthorized person deterrent apparatus has a ingress cover closing mechanism.

11. The unauthorized person deterrent apparatus of claim 10, wherein the operation of the ingress cover closing mechanism operates the ingress cover from a first open position to a second closed position.

12. The unauthorized person deterrent apparatus of claim 1, wherein the unauthorized person deterrent apparatus has a opening mechanism part.

13. The unauthorized person deterrent apparatus of claim 1, wherein the a ingress cover opening mechanism deactivator switch is selected from a group consisting of: solid state switch, microprocessor controlled switch, a microprocessor, a computer based switch, a cell phone button, a smart phone application, a smart phone button, a touch screen button, an icon, a timer, a computer icon button, an icon on a computer screen, an icon on a mobile device, an icon on a wearable optical electronic device, an icon in augmented reality glasses, sound command given via bone conduction device, a programmed button on a telephone, a button on a radio device, a switch on a wireless device, a motion detecting device, an optical device, a photo electric device, a sound activated device, voice activated device, a gesture controlled device, an eye motion activated device, a software application.

14. A method of using a unauthorized person deterrent apparatus comprising:
providing a ingress cover;
providing a ingress cover opening mechanism;
providing a ingress cover opening mechanism deactivator;
providing a ingress cover opening mechanism deactivator switch;
wherein operating the ingress cover opening deactivator switch causes: the operation of the ingress cover opening mechanism deactivator, the ingress cover opening mechanism to deactivate, and the ingress cover to close

15. A unauthorized person deterrent system comprising:
a ingress cover;
a ingress cover opening mechanism;
a ingress cover opening mechanism deactivator;
a ingress cover opening mechanism deactivator switch;
wherein the operation of the ingress cover opening deactivator switch causes: the operation of the ingress cover opening mechanism deactivator, the ingress cover opening mechanism to deactivate, and the ingress cover to close.
